(19) United States
(12) Patent Application Publication
(10) Pub. No.: US 2004/0209147 A1
(43) Pub. Date: Oct. 21, 2004

(54) Sealing structure for a fuel cell, as well as a method for producing it, and a fuel cell with the sealing structure

(76) Inventors: Olav Finkenwirth, Munchen (DE); Hans-Rainer Zerfass, Taunusstein (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/761,124

(22) Filed: Jan. 20, 2004

(30) Foreign Application Priority Data
Jan. 21, 2003 (DE) 103 02 122.1-45

(51) Int. Cl. H01M 2/08; H01M 8/12; H01M 4/86; B05D 5/12

(52) U.S. Cl. 429/35; 429/30; 429/36; 429/45; 427/115

(57) ABSTRACT

A sealing structure for a fuel cell and/or an electrolyzer, in particular a solid electrolyte fuel cell and/or a solid electrolyte electrolyzer, wherein the sealing structure (14a, 14b) is arranged between adjoining separator plates (7, 8) of a cell stack (1), wherein the sealing structure (14, 14a, 14b) is embodied in at least two layers and has at least one insulating layer (14a) and at least one sealing layer (14b), wherein the insulating layer (14a) is arranged on a separator plate (7, 8).

### BACKGROUND OF THE INVENTION

1. Field of the Invention

The invention relates to a sealing structure for a fuel cell and/or an electrolyzer, in particular a solid electrolyte fuel cell and/or a solid electrolyte electrolyzer. The invention also relates to a method for producing a fuel cell and/or an electrolyzer, in particular a solid electrolyte fuel cell and/or a solid electrolyte electrolyzer. Finally, the invention also relates to a fuel cell or an electrolyzer, in particular a solid electrolyte fuel cell and/or a solid electrolyte electrolyzer.

2. Description of Related Art

A fuel cell stack 1 in accordance with FIG. 2 is known from the prior art. This fuel cell stack has one or a plurality of individual fuel cells 2, which are stacked on top of each other in the manner of a tower. The fuel cells 2 have an electrolyte layer 3, a cathode layer 4 arranged on one of the flat sides of the electrolyte layer 3, and an anode layer 5 arranged on the other flat side of the electrolyte layer 3. A contact layer 6 is seated on the cathode layer 4 for contacting an adjoining fuel cell 2. Furthermore, each individual fuel cell 2 has a first separator plate 7 and a second separator plate 8. The separator plates 7, 8 enclose a combustion gas chamber 9, wherein the anode layer 5 protrudes into the combustion gas chamber 9. The combustion gas chamber 9 is connected with the anode layer 5 in such a way that combustion gases flowing through the combustion gas chamber 9 (direction of the arrow 10) can come into contact with the free surface of the anode layer 5.

An oxidation gas chamber 11 is formed between a second separator plate 8 of a fuel cell 2 and a first separator plate 7 of an adjoining fuel cell 2, through which oxidation gas (direction of the arrow 12) can flow, so that oxidation gas can flow against the free surface of the cathode layer 4 protruding into the oxidation chamber 11. The contact layer 6 whose flat side is in contact with the cathode layer 4, as described above, touches with its second flat side, which faces the oxidation chamber 11, a flat side of the separator plate 7 of the adjoining individual fuel cell 2. All combustion gas chambers 9 of a fuel cell stack 1 are connected with each other by means of corresponding openings in the first and second separator plates 7, 8. In an area between a second separator plate 8 and a first separator plate 7 of an adjoining individual combustion chamber 2, the combustion gas chambers 9 are separated in a gas-tight manner from the oxidation gas chambers 11 by means of a thin layer 14, so that a fuel supply conduit 15 and an outlet conduit 16 for the reaction products are formed. In this way combustion gas can be supplied to the combustion gas chambers 9 in the direction of the arrow 18 and flows through the latter along the direction of the arrow 10, wherein the combustion gas is oxidized in a fuel cell 2 along the anode layer 5 and can leave the fuel cell stack 1 again in the direction of the arrow 19 in the form of a reaction product. The oxidation gas is conducted through the oxidation gas chambers 11 via appropriately embodied supply and outlet conduits in a manner analogous to the combustion gas.

Thus, the separator plates 7, 8 of an above described fuel cell stack 1 have as a function on the one hand the connection of the individual fuel cells 2, which are switched in series, in an electrically conductive manner and, on the other hand, the assurance of the separation of the combustion gas from the oxidation gas. For this purpose the separator plates 7, 8 (also called bipolar plates or interconnector plates) are made of a material which is gas-tight, in particular combustion gas- and oxidation-gas-tight, and is capable of electronic transmission, wherein chromium-containing alloys, ferritic steel and perovskite have been proven to be particularly effective. For assuring a dependable separation of the oxidation gases and the combustion gases from each other it is required to provide a dependable sealing of the supply conduits 15 and the production gas outlet conduits 16 from the oxidation gas chamber 11 between each second separator plate 8 of a first fuel cell 2 and the first separator plate 7 of an adjoining fuel cell 2.

From the prior art it is known to form the sealing layer 14 of glass-ceramic solder, for example. This glass-ceramic solder is customarily applied as a paste or solubilized foil to the relevant sealing faces of the separator plates 7, 8 prior to joining a fuel cell stack 1 together.

These sealing materials (glass-ceramic solder) customarily being employed in connection with solid electrolyte fuel cells have two oppositely acting properties. With respect to the thermal expansion coefficients of most materials used for the bipolar plates 7, 8, the thermal expansion coefficient of the sealing material is definitely smaller. In the course of rapid heating of the fuel cell stack 1 this can lead to thermally induced tension cracks in the sealing layer 14, and therefore to the failure of their sealing effect. This is particularly critical in connection with solid electrolyte fuel cells (so-called SOFC stacks) operating in a high temperature range. This presents a problem in particular in connection with solid electrolyte fuel cells which are stressed by frequent start-ups and stops, which so far has not been satisfactorily solved.

In the prior art it is known to increase the coefficient of expansion of the sealing materials by the addition of metal ingredients or metallic oxide ingredients to the sealing material. However, these additives necessarily lead to a reduction of the electrical resistance of the sealing material at the typically high operating temperatures of a solid electrolyte fuel cell. This causes undesirable leak currents via the sealing layer 14 between a second separator plate 8 and a first separator plate 7 of two adjoining individual fuel cells 2, which worsens the electrical effectiveness of a fuel cell stack 1 in an undesirable manner.

A further disadvantage of the sealing known from the prior art in accordance with FIG. 2 is that the known materials for the sealing layer 14 have a different compression behavior and/or shrinking characteristic in comparison with the contact layer 6, which leads to undesirable inaccuracies in the course of assembling a fuel cell stack 1, which can make the dependable contact of the contact layer 6 with an adjoining separator plate 7 questionable. Moreover, it is disadvantageous that making a suitable sealing layer 14 available prior to joining the fuel cell stack 1 together is elaborate and expensive, for example because a sealing material strand must be produced or, in the case of a foil-like embodiment of the sealing layer 14, it must be separately produced and positioned, or embedded prior to the joining process.

A sealing structure of a fuel cell is known from DE 195 15 457 C1, in which the electrolyte layer consists of an electrolyte matrix soaked in electrolyte and in the sealing area the electrolyte matrix is embodied to extend beyond the electrodes, wherein the soaking of the electrolyte matrix in the sealing area is performed with a material which is chemically related to the electrolyte and is stable at the operating temperature of the fuel cell. However, the proposed solution relates to a so-called melt carbonate fuel cell having a melt electrolyte which is provided in liquid form in an electrolyte matrix. This type of fuel cell customarily addresses a wet sealing area, since the electrolyte is liquid in the operating state and forms a wet area in the edge area which is to be sealed. However, this solution cannot be applied to a solid electrolyte fuel cell, since in connection with such a solid electrolyte fuel cell (SOFC=solid oxide fuel cell) there are no so-called wet electrodes or wet electrolytes, so that the problem in connection with DE 195 15 457 C1 does not occur because of the type of construction.

A seal for a fuel cell is known from DE 199 60 516 A1, in which an electrolyte membrane is extended into the edge sealing area between two separator plates and a dual-coated rubber seal is arranged on the electrolyte membrane. For the structure of the seal it is suggested to make one layer of a soft rubber foam, and the other layer of a harder rubber, for example silicone rubber or butyl rubber. This publication relates to a so-called low-temperature fuel cell with a polymer membrane electrolyte. These so-called low-temperature fuel cells have operating temperatures which lie in the range between 60° C. and 80° C. The operating temperatures of such fuel cells is not comparable with a solid electrode fuel cell, since solid electrode fuel cells are customarily operated in temperature ranges between 700 and 1100° C. Therefore the seal proposed in DE 199 60 516 A1 cannot be applied to a solid electrolyte fuel cell because of the high operating temperatures of the latter.

A fuel cell construction is known from JP 10-092450 A, which is similar to that in accordance with FIG. 2 and defines the prior art.

### SUMMARY OF THE INVENTION

It is an object of the invention to disclose a sealing structure for a fuel cell and/or an electrolyzer, in particular a solid electrolyte fuel cell, which is insensitive to thermal tension and at the same time assures an electrical, in particular an electronic insulation, i.e. an impenetrability by electrons. The sealing structure is furthermore intended to be simple and cost-effective and, in particular in comparison with the prior art, without additional process steps. Moreover, the compressibility and/or the shrinking behavior of the sealing structure is to be matched to that of the contact layer and therefore to make possible an easier and, in particular, process-dependable assembly.

Within the scope of this invention, a thin ceramic element is applied by means of a thermal coating process between a separator plate and a sealing layer to counteract the lack of electrical insulating capabilities of certain sealing materials. In accordance with the invention, the thermal coating process is preferably the same process with which the ceramic SOFC layers, i.e. the anode, electrolyte and cathode layers, are applied (for example, vacuum plasma spraying, atmospheric plasma spraying, etc.). From the viewpoint of production techniques the insulating ceramic element is ideally applied in one process step together with the electrolyte of the SOFC and consists of the same material. However, it is also conceivable that in an additional coating step, but using similar production technique, other materials are employed for the electrical insulation which, for example, are more cost-effective and/or have better insulating properties than the electrolyte material.

Therefore the ceramic insulating layer should have a very high electronic resistance and its thermal expansion behavior should be matched to the separator plate material. If, for example, the SOFCs are produced by means of the vacuum plasma spraying process, the application processes for sealing face insulation and electrolyte can take place at the same time or one after the other. In the course of vacuum plasma spraying a plasma burner passes over the surface of the fuel cells in a way similar to a spray gun and deposits a thin layer of electrolyte material during each passage. This process is repeated several times until the desired electrolyte layer thickness has been achieved. If now the process path of the plasma burner is appropriately extended so that it also passes over the sealing faces of the fuel cell, the required sealing-insulating layer is applied in parallel or sequentially with a minimal extra effort. To achieve the optimal adhesion of the insulating layer on the sealing faces of the bipolar plates (namely the separator plates), it might possibly be necessary to roughen their surfaces, for example by means of a sand-blasting method.

The invention is particularly advantageous because the prevention of electrical shorts or leak currents between the individual cell elements of a fuel cell stack is an absolute necessity for achieving the desired area-specific electrical output density per square centimeter. The application of an electrically insulating ceramic layer to the sealing faces of the bipolar plates of solid electrolyte fuel cells makes possible the employment of sealing materials for separating and distributing the combustion and oxidation gases, which are only insufficiently electrically insulating, wherein the thermal expansion behavior of these sealing materials, which are only insufficiently electrically insulating, can be more easily and better matched to the expansion behavior of the separator plates.

Furthermore, the use of electrically conductive sealing materials makes possible the employment of materials which are better matched to the thermal coefficients of expansion of the separator plates, so that the probability of a failure of the sealing function because of rapid thermal cycles, such as are required, for example, in connection with the employment of a solid electrolyte fuel cell in a mobile generator unit, is reduced.

The employment of the electrical insulating layers is particularly advantageous when the electro-chemically active cathode-electrolyte-anode unit (called CEA or MEA) of the solid electrolyte fuel cell is produced by means of a thermal coating process. In this case the same production process can be used for the application of the insulation materials as for the application of the electro-chemically active layers. A further simplification of the application process lies in the application of the electrolyte material, which is not electronically conductive, parallel with the production of the electrolyte. In both cases only the possibly required roughening of the surface of the sealing face (for example by means of sandblasting) and the increase of the displacement range of the coating tool used for the application of CEA (for example a plasma burner) is required as a prior process step. These changes represent a minimal additional outlay. A further advantage of the use of thin film ceramic elements as the insulating material is the possible matching of their thermal coefficients of expansion by means of a definite selection of material. In the entire range of the employed temperatures from the ambient to the operating temperature, the coefficient of expansion of the insulating layer should lie between that of the bipolar plates/sheets (separator plates) and that of the sealing material, so that the adhesion of the seal is improved even at rapid thermal cycles.

### BRIEF DESCRIPTION OF THE DRAWINGS

The invention will be explained by way of example in greater detail by means of the drawings.

FIG. 1 represents a schematic cross section through a fuel cell in accordance with the invention, having a sealing structure in accordance with the invention,

FIG. 2 represents a schematic cross section through a fuel cell in accordance with the prior art.

### DESCRIPTION OF PREFERRED EMBODIMENTS

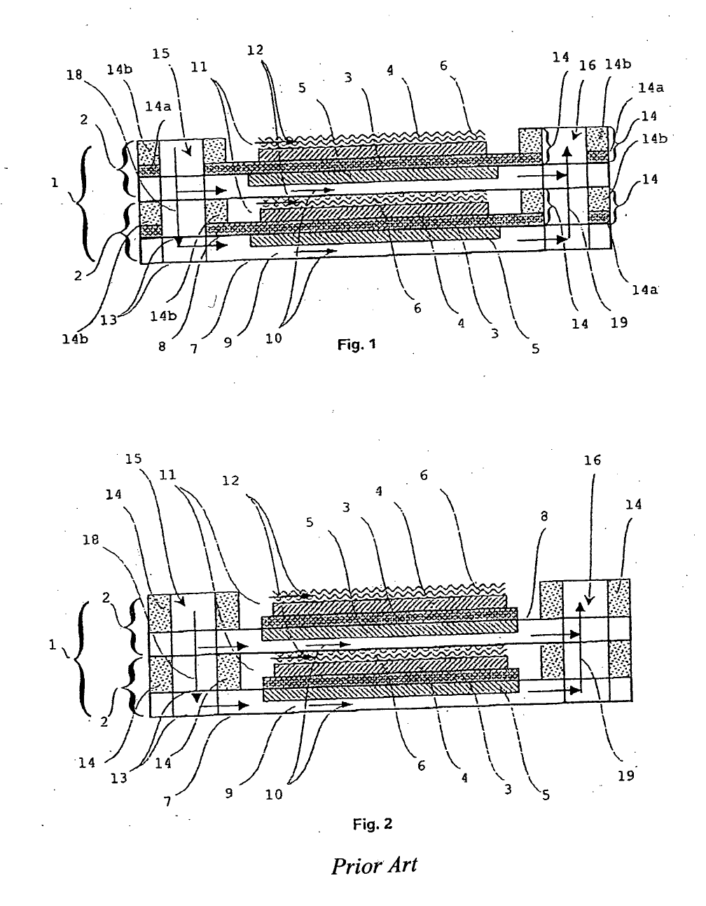

A sealing structure 14a, 14b in accordance with the invention is suitable for a fuel cell stack 1 in accordance with the invention represented in FIG. 1, including individual fuel cells 2 embodied as high-temperature fuel cells, in particular as solid electrolyte fuel cells (SOFCs), having an electrolyte layer 3, a cathode layer 4 and a anode layer 5. The electrically effective layers 3, 4, 5 are possibly arranged on a porous metallic substrate layer (not represented), which is preferably embodied as a mechanically supporting layer. Moreover, combustion gas can reach the anode 5 through the porous metallic substrate layer. The porous metallic substrate layer is embodied, for example, as a nickelous felt element or as FeCrAlY foam. The anode layer consists, for example, of a nickel/yttrium-stabilized zirconium dioxide (Ni—YSZ) cermet material, the electrolyte layer 3 is embodied to be oxygen-conducting and consists, for example, of Y₂O₃-stabilized zirconium oxide and is embodied to be gas-tight against the reaction gases employed in the fuel cell 2 and is only permeable for O₂ ions. The cathode layer 4 consists for example of lanthanum-strontium-doped manganese (LSM). The cathode layer 4 and the anode layer 5 are embodied as porous layers, possibly of graded material composition and graded porosity.

The electrically effective layers 3, 4, 5 are embodied as so-called thin-film ceramic layers. The electrolyte layer 3 advantageously has a thickness of approximately 20 to 50 μm, in particular 20 μm. The cathode layer 4 and the anode layer 5 preferably have thicknesses of approximately 20 to 50 μm. As supporting layer, the porous metallic substrate layer is embodied to be approximately 1000 μm thick. The embodiment of the electrolyte layer 3 as a thin-film ceramic layer through which the O₂ ions must pass, assures a low consumption of materials and low electrical losses.

The contact layer 6 consists of a porous and ductile material, so that a contact of low impedance with the adjoining separator plate 7 is assured. A further essential property of the thin-film ceramic electrolyte layer 3 is its gas-impermeability along with a simultaneous permeability for O₂ ions and a high resistance to electrons.

The thin-film ceramic layers 3, 4, 5 are preferably applied to the porous metallic substrate layer by means of spray methods, for example plasma spraying, atmospheric plasma spraying, flame spraying, etc. in sequential layers.

In accordance with the invention, the structure of the sealing layer 14 between two adjoining separator plates 7, 8 is provided in at least two layers of a first layer 14a and a second layer 14b. The first layer 14a (insulating layer) here is an electronically insulating thin-film ceramic layer which assures the complete insulation between adjoining separator plates 7, 8. The second layer 14b is a sealing layer and includes, for example, a glass-ceramic solder or an alkali-silicate-containing high temperature ceramic adhesive which, by means of suitable additives, is matched to the thermal coefficient of expansion of the separator plates 7, 8. Metallic ingredients or metallic oxide ingredients are suitable additions of materials to such a glass-ceramic solder.

However, a relatively high electrical conductivity of the sealing material used is easily acceptable in accordance with the invention, because the first sealing layer 14a assures the electrical insulation between adjoining separator plates 7, 8 to a sufficient degree. Also, in connection with the at least dual-layered sealing structure 14a, 14b in accordance with the invention it is possible to match the compressibility and/or the shrinking behavior of the sealing layer 14b to the compressibility and/or the shrinking behavior of the contact layer 6 by means of a suitable selection of the materials, so that in the course of joining the individual fuel cells 2 into a fuel cell stack 1 the contact of the contact layer 6 with an adjoining separator plate 7 is dependably assured even after the first heating of the fuel cells to their operating temperature (700 to 1100° C.).

In accordance with a particularly preferred embodiment of the fuel cell 2 in accordance with the invention, or of the sealing structure 14, 14a, 14b in accordance with the invention, the first insulating layer 14a of the insulating structure 14 includes the same material as the electrolyte layer 3, since this material is permeable to O₂ ions, i.e. is “conductive” for O₂ ions, but is a good insulator against electrons. In connection with this embodiment it is particularly advantageous that the first layer 14a (electronic insulating layer) can be produced in one process step along with the production of the electrolyte layer 3 simply by extending the displacement range of a plasma coating nozzle. In this case the displacement range of the nozzle has been selected to be such that the plasma coating nozzle also passes over the area of all required sealing locations in addition to the area of the electrolyte layer 3 and applies electrolyte material there. Alternatively, the first layer 14a can be applied to the fuel cell either before or after the electrolyte layer 3 is applied to the fuel cell.

Prior to applying the first layer 14a in the sealing areas, the involved surface sections of the separator plates 7, 8 are preferably roughened, for example by means of a sandblasting process, so that the mechanically firm connection of the sealing structure 14, 14a, 14b with the separator plates 7, 8 is assured. Following the application of the insulating layer 14a, the second layer 14b, for example consisting of a pasty glass-ceramic solder, which is matched in its material properties, for example a glass-ceramic solder or a foil, is applied in a known manner. These sealing materials are customarily applied in the form of pastes or solubilized foils to the intended sealing faces.

In accordance with a particularly preferred embodiment, the electrolyte layer 3 is embodied as continuously extending into the sealing areas in such a way that at least partial areas of the electrolyte layer 3 constitute parts of the insulating first layer 14a of the sealing structure 14, 14a, 14b (FIG. 1).

Thus, all known demands made on a sealing structure of this type (low hydrogen leakage rates, low electrical conducting capability, satisfactory bonding with the bipolar plates, agreement of the thermal coefficients of expansion of the seal and the separator plates, chemical resistance to the media to be sealed, permanence of the operating temperature and deformation behavior matched to the fuel cell during the joining process) have been satisfactorily met to a particular extent by means of the sealing structure 14, 14a, 14b in accordance with the invention for a fuel cell stack 1.

What is claimed is:

1. A sealing structure for a fuel cell, in particular a solid electrolyte fuel cell, wherein the sealing structure is arranged between adjoining separator plates of a cell stack, wherein the sealing structure comprises at least two layers including at least one insulating layer and at least one sealing layer, wherein the insulating layer is arranged on a separator plate.

2. The sealing structure in accordance with claim 1, wherein the insulating layer comprises a ceramic material, in particular an electronically insulating ceramic material.

3. The sealing structure in accordance with claim 1, wherein the insulating layer comprises an electrolyte material, in particular of Y₂O₃-stabilized zirconium dioxide.

4. The sealing structure in accordance with claim 1, wherein the sealing layer comprises a pasty sealing material selected from the group consisting of a glass-ceramic solder and an alkali-silicate-containing high-temperature ceramic adhesive.

5. The sealing structure in accordance with claim 1, wherein the sealing layer comprises a material having the same thermal expansion behavior as at least one of the separator plates.

6. The sealing structure in accordance with claim 1, wherein the sealing layer comprises a metal or metal oxide additive.

7. The sealing structure in accordance with claim 1, wherein the sealing structure is arranged in a fuel cell stack of a plurality of individual fuel cells.

8. The sealing structure in accordance with claim 7, wherein the individual fuel cells comprise high-temperature fuel cells, in particular solid electrolyte fuel cells (SOFCs), each comprising electrically effective layers including an electrolyte layer, a cathode layer and an anode layer.

9. The sealing structure in accordance with claim 8, wherein the electrically effective layers are arranged on a mechanically supporting layer comprising a porous metallic substrate layer.

10. The sealing structure in accordance with claim 9, wherein the metallic substrate layer is porous, such that combustion gas can reach the anode layer.

11. The sealing structure in accordance with claim 9, wherein the porous metallic substrate layer comprises at least one of the group consisting of a nickelous felt element and a FeCrAlY foam.

12. The sealing structure in accordance with claim 8, wherein the anode layer comprises a nickel/yttrium-stabilized zirconium dioxide (Ni—YSZ) cermet material.

13. The sealing structure in accordance with claim 8, wherein the electrolyte layer is oxygen-conducting and electronically insulating.

14. The sealing structure in accordance with claim 8, wherein the electrolyte layer is gas-tight.

15. The sealing structure in accordance with claim 8, wherein the cathode layer comprises lanthanum-strontium-doped manganese (LSM).

16. The sealing structure in accordance with claim 8, wherein the cathode layer and the anode layer comprise porous layers having a graded material composition and graded porosity.

17. The sealing structure in accordance with claim 8, wherein the electrically effective layers comprise thin-film ceramic layers.

18. The sealing structure in accordance with claim 8, wherein the electrolyte layer has a thickness of approximately 20 to 50 μm.

19. The sealing structure in accordance with claim 8, wherein the cathode layer and the anode layer each have a thickness of approximately 20 to 50 μm.

20. The sealing structure in accordance with claim 1, further comprising a contact layer, which comprises a porous material that is ductile in an assembly state.

21. The sealing structure in accordance with claim 20, wherein the sealing layer is matched to at least one of the group consisting of compressibility and shrinking behavior of the contact layer.

22. The sealing structure in accordance with claim 8, wherein the electrolyte layer extends into a sealing area in such a way that at least a partial area of the electrolyte layer forms at least a portion of the insulating layer of the sealing structure.

23. The sealing structure in accordance with claim 1, wherein in an entire range of employed temperatures from ambient to an operating temperature of a fuel cell, a coefficient of expansion of the insulating layer lies between that of the separator plates and that of the sealing layer.

24. A method for producing a sealing structure for a fuel cell, in particular a solid electrolyte fuel cell, comprising the steps of applying an insulating layer of the sealing structure onto at least one predetermined sealing area of at least one separator plate of a fuel cell, and applying a sealing layer of the sealing structure to the fuel cell.

25. The method in accordance with claim 24, comprising the step of using a thermal coating process to apply the insulating layer.

26. The method in accordance with claim 25, comprising the step of using the thermal coating process to apply an electrolyte layer to the fuel cell.

27. The method in accordance with claim 25, wherein the thermal coating process comprises at least one of the group consisting of vacuum plasma spraying and atmospheric plasma spraying.

28. The method in accordance with claim 24, comprising applying the insulating layer in one process step along with applying an electrolyte layer to the fuel cell.

29. The method in accordance with claim 24, comprising applying the insulating layer while simultaneously applying an electrolyte layer to the fuel cell.

30. The method in accordance with claim 24, further comprising roughening the at least one predetermined sealing area of the at least one separator plate prior to being coated with the insulating layer.

31. The method in accordance with claim 24, comprising producing a solid electrolyte fuel cell stack.

32. The method in accordance with claim 28, comprising applying the insulating layer and the electrolyte layer using an extended displacement area of a plasma coating nozzle.

33. The method in accordance with claim 32, wherein in the course of coating the plasma coating nozzle travels over all required sealing locations and applies electrolyte material there.

34. The method in accordance with claim 24, wherein the sealing layer is applied after the application of the insulating layer.

35. A fuel cell, in particular a solid electrolyte fuel cell, comprising a sealing structure arranged between adjoining separator plates of a cell stack, wherein the sealing structure comprises at least two layers including at least one insulating layer and at least one sealing layer, wherein the insulating layer is arranged on a separator plate.
